(19) United States
(12) Patent Application Publication
(10) Pub. No.: US 2026/0087874 A1
(43) Pub. Date: Mar. 26, 2026

(54) SYSTEMS AND METHODS FOR A RANDOMIZED AMUSEMENT GAME

(71) Applicant: Amuse d.o.o., Ljubljana (SI)

(72) Inventors: Jelle BAKKER, Wervershoof (NL); Olaf TER BRAACK, Haarlem (NL); Stijn VAN WOERKOM, Haarlem (NL); Dave KEUNE, Haarlem (NL)

(21) Appl. No.: 19/340,242

(22) Filed: Sep. 25, 2025

Related U.S. Application Data
(60) Provisional application No. 63/699,678, filed on Sep. 26, 2024.

(51) Int. Cl. G07F 17/32; G06K 19/07

(52) U.S. Cl. CPC G07F 17/3216; G06K 19/0723; G07F 17/3211; G07F 17/3269

(57) ABSTRACT

The present disclosure describes an amusement game comprising a plurality of game elements, a rotatable game board with protruding obstacles, a finish lane, and a computing device. The plurality of game elements are released into an upper portion of the rotatable game board. The rotatable game board is rotated for a first period of time. One or more wagers may be accepted for the first period of time. At an expiration of the first period of time, the rotation of the rotatable game board may cease. The plurality of game elements are configured to move toward a finish gate at a lower portion of the rotatable game board and enter a finish lane in a chronological order of arrival to the finish gate. The computing device may display, based on the order of arrival of the plurality of game elements, a finishing order of the game elements of the game.

### CROSS REFERENCE TO RELATED APPLICATIONS

This application claims benefit under 35 U.S.C. §119(e) of Provisional U.S. Patent Application No. 63/699,678, filed September 26, 2024, the contents of which is incorporated herein by reference in its entirety.

### TECHNICAL FIELD

The present disclosure relates generally to the field of gaming, primarily to amusement games that may be wagered on.

### BACKGROUND INFORMATION

Casinos offer a wide variety of games and experiences to provide excitement to the broad range of users who may travel to casinos for entertainment. Casinos offer card games, dice games, table games, slot games, sports betting games, and the games offered may take place on physical gaming equipment or digitally. Portions of games may remain in physical form while other portions are operated digitally. For example, games may use digital player stations that users can interact with to play physical casino games.

Game offerings are constantly evolving to meet player preferences and to continue to entice players to try new experiences. Though casino games typically involve betting on card or dice games, other types of games have become more popular, for example amusement games that users may wager on.

### SUMMARY

An embodiment is directed to a system for operation of an amusement game comprising a plurality of game elements, a rotatable game board comprising a plurality of protruding obstacles, a finish lane comprising a plurality of finish position markers, and a computing device. The computing device may cause release of the plurality of game elements into an upper portion of the rotatable game board to begin a game. The computing device may cause, for a first period of time, rotation of the rotatable game board. The computing device may accept, for the first period of time, one or more wagers associated with a finishing position of one or more of the plurality of game elements. The computing device may cause, at an expiration of the first period of time, cessation of the rotation of the rotatable game board, wherein the plurality of game elements are configured to move toward a finish gate at a lower portion of the rotatable game board and enter a finish lane in a chronological order of arrival to the finish gate. The computing device may display, based on the order of arrival of the plurality of game elements, a finishing order of the game elements of the game.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a perspective view of an amusement game, in accordance with an embodiment.

FIG. 2A is a view of an amusement game, in accordance with an embodiment.

FIG. 2B is a view of the amusement game shown in FIG. 2A at a different time, in accordance with an embodiment.

FIG. 3 is a view of a portion of an amusement game, in accordance with an embodiment.

FIG. 4 is a view of a portion of an amusement game, in accordance with an embodiment.

FIG. 5 is a view of a portion of an amusement game, in accordance with an embodiment.

FIG. 6 is a perspective view of an amusement game, in accordance with an embodiment.

FIG. 7 is a flow chart of an example method of operating an amusement game, in accordance with an embodiment.

FIG. 8 is an example of a computing system, in accordance with an embodiment.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are systems and methods for presenting an amusement game for users to play. For example, the disclosure herein is directed to a plinko-style game in which a group of gaming elements, for example marbles, are released at the top of a game board with obstacles protruding from the game board. The marbles may bounce down through the obstacles, for example pegs protruding from the game board, and travel toward a bottom collection area of the system. Additionally, the game board may rotate. Thus, the game elements, such as marbles, may bounce down from a top of the game board to a bottom finishing area of the game board, but the game board may rotate, causing the marbles to be moved away from the bottom finish area of the game board.

A computing device associated with the amusement game system, either built into the gaming device or in a separate server style configuration, may be configured to calculate a rate of travel for the marbles. The rate of travel may not be perfectly known due to the randomness of the marbles impacting particular obstacles and changing course while travelling down toward the finish area of the game board. However, the computing device may be able to determine a likely rate of travel for the marbles on the game board. With the likely rate of travel the computing device may be able to rotate the game board at a particular rate that is substantially likely to keep all of the marbles bouncing around on the game board without reaching the finish area for at least a period of time. For example, the computing device may be able to keep the marbles bouncing around on the rotating game board for a period of 15 seconds, 30 seconds, 45 seconds, one minute, two minutes, or any quantity of time desired. The game board may then be stopped, at which point the marbles may bounce through the obstacles to the finish area of the game board. The rotations of the game board may also be random movements selected from within a group permissible movements based on the likely rate of travel.

At the finish area there may be a gate that is large enough for one marble to pass through at a time, but too small for two marbles to pass through simultaneously. Thus, as the marbles traverse through the obstacles and fall toward the finish area, the marbles may pass through the gate in an order of their chronological arrival at the gate. The marbles may pass through the gate into a finish lane.

The finish lane may be large enough to accommodate one marble but too narrow to accommodate two or more marbles side by side. As the marbles fall to the bottom of the game board and pass through the finish gate, the marbles may line up in the finish lane in the order of arrival. In this way, the marbles may be ranked in an order of first to finish, all the way to a last marble that is last to finish traversing through the obstacles of the game board and into the finish lane. The finish lane may be visible to users interacting with the game to easily show the finish order of the marbles. Users may be at the location of the game board or may be located remotely from the location, and the users may place wagers on the outcome of games on the game board.

Cameras may be installed on or around the game board to provide live video images of the games being played on the game board. The cameras may provide the live images to be transmitted to users viewing the games locally or remotely. The cameras may provide the live images to be transmitted to users sitting at player stations at the location of the game board. The cameras may provide the live images to be displayed on display screens near the game board that may be easily viewed by users in a vicinity of the game board. For example, the display screens may show larger than real views of the games while in progress and at a conclusion of the games. Thus, users in the vicinity of the game board but not close enough to effectively see an outcome of a game may view the display screens to see the outcome of the game. The display screens may also display information related to the outcomes of the games. For example, the display screens may display information related to wagers made on the games. The game board may be manually operated, automatically operated, or partially manually and partially automatically operated. The computing device may comprise hardware and software programs used to manage and transmit information related to the games.

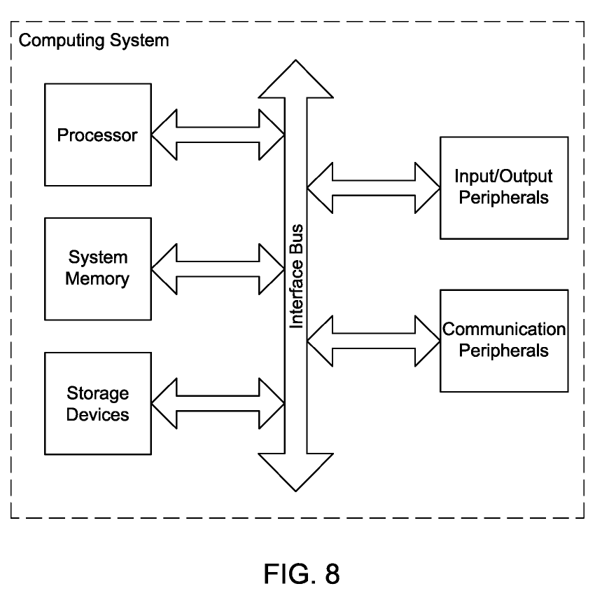

The cameras may be fixed in place or movable. The cameras may be controlled by software of the computing device, such as the computing device shown in FIG. 8. The computing device may comprise a server device implemented to manage sending the live video images and other information about the game board and game outcomes to users located remotely from the game board or to player stations located about the game board. The games may be livestreamed to the remote users and player stations. The server device may implement a host system to electronically manage the device and/or the livestreaming the games to remotely located audiences.

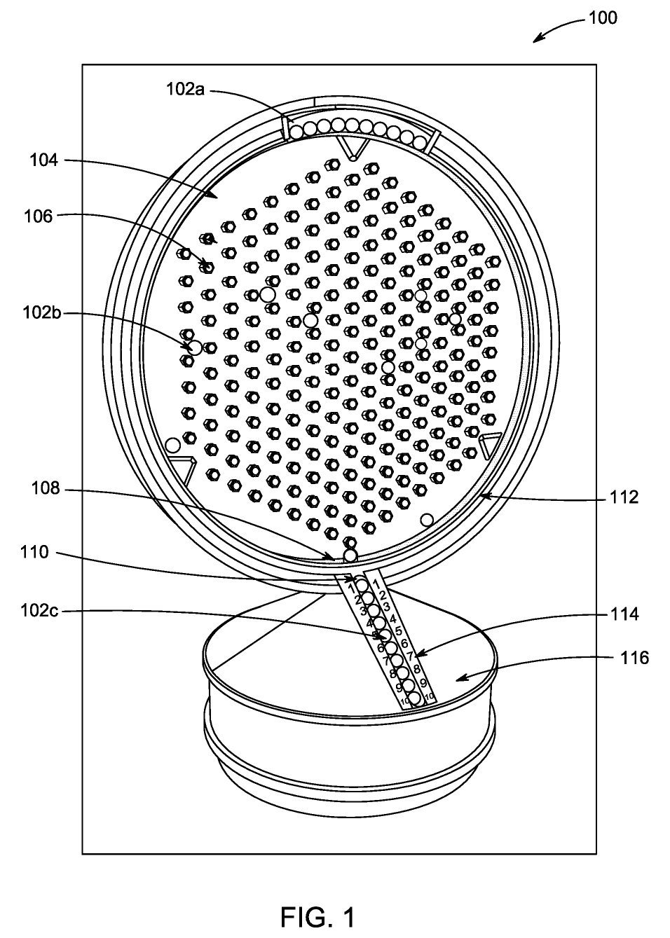

FIG. 1 shows an example amusement game system 100, as described above. The amusement game device may comprise a game board 104 that facilitates the game. The marbles 102 may traverse through the game board 104 during each game from a top to a bottom of the game board 104. The game board 104 may be rotated during the games to change a direction of the marbles 102 in a play area of the game board 104. The rotation may cause a change in direction of the marbles 102 falling down through the game board 104 and build suspense and excitement about which marbles 102 will first pass through a finish gate 108.

The marbles 102a may be held in a hopper above the top of the rotating game board 104, and upon initiation of a game the marbles 102a may be released into the game board 104. The marbles 102b actively in transit through the game board 104 may, as a result of rotation of the game board 104, take seconds or minutes to traverse through the game board 104 and to the finish gate 108, typically depending on a length of a period of time the game board 104 is rotated. The game board 104 may be rotated in either direction. Though typically only rotated in one direction for the entirety of a game, the game board 104 rotation may change direction during the middle of an active game. Marbles 102c have passed through the game board 104 and reached the finish lane 110. Marbles 102c are lined up in the finish lane 110 in the order they passed through the finish gate 108 and are displayed as an outcome of a game.

The finish lane 110 may show the marbles in an ordering of first to last or last to first. Thus, the marble farthest away from the game board 104 may be the marble 102c that passed through the finish gate 108 first, or the marble 102c that is closest to the game board 104 in the finish lane 110 may be the marble 102c that passed through the finish gate 108 first. Though the finish lane 110 is shown as a single-file lane of the marbles, other embodiments are contemplated herein. For example, the finish lane 110 may comprise a square grid, for example a 3x3 grid. Nine marbles may be used in a game with a finish lane 110 having a 3x3 square grid. The configuration of the marbles 102c in the 3x3 grid may correspond to an outcome of the game. For example, classic slot machines typically reveal a 3x3 grid of symbols, and determinations of winning and losing wagers on the classic slot machines is determined by the configuration of the symbols. In the same way, the outcome of the ordering of the marbles 102c in the 3x3 grid version of the finish lane 110 may be determined by the configuration of the marbles 102c. For example, three of the nine marbles may be a same color, and a game may be considered a win if the three marbles of the same color are aligned vertically, horizontally, and/or diagonally. Many such combinations of marbles and grids may be possible to enhance the novelty and excitement of the amusement game system. Marbles may be printed with different numbers, colors, or symbols that correspond to particular outcomes of games. The marbles may not be printed with any visible differences, but the marbles may be identifiable. For example, the marbles may comprise radio frequency identifier (RFID) tags, and an RFID sensor may be able to determine the order of the marbles in the finish lane 110. The finish lane 110 may be too small to accommodate every marble, and only some marbles may enter the finish lane 110, which is another mechanism for determining outcomes of the amusement games.

The game board 104 may comprise one or more back lights to light up the game board 104 and finish lane 110. For example, the back lights may be light emitting diodes (LEDs), incandescent lights, fluorescent lights, or the like. The game board 104 may include a liquid crystal display that covers the outwardly visible portion of the game board and provides the back lights. The back lights may be inset in a rim of the game board 104 to cast light inward on to the game board 104 to increase illumination of the marbles 102b. The back lights may be behind the game board 104 and illuminate through the game board 104. The back lights may also be installed in each of the obstacles 106. When a marble 102b touches an obstacle 106, which may be sensed by one or more sensors, the back light for that obstacle 106 may be lit. Though not shown in FIG. 1, the back lights may also be present in the order indicators 114 that show an order of the marbles 102c. The back lights of the order indicators 114 may illuminate the order indicators 114 themselves, or the back lights may illuminate the finish lane 110. The back lights in both the game board 104 and the area near the order indicators 114 and finish lane 110 may change color. The back lights may change color periodically or based on certain conditions of the games. The back lights may change color to match a color or other identity of a marble 102b passing through the finish gate 108 or settling into a position in the finish lane 110.

The obstacles 106 on the game board 104 may be similar to pegs. The obstacles 106 may be circular and cause the marbles 102b to ricochet upon making impact. The obstacles 106 may be square, oblong, multi-sided, or any other shape. The obstacles 106 may be placed in a repeating manner and each obstacle 106 may be at a constant distance from other obstacles 106 on the game board 104. The obstacles 106 may be configured to keep the marbles 102b against the game board 104. The obstacles 106 may have a relatively narrower shaft and a relatively wider head to prevent the marbles 102b from ricocheting out away from the surface of the game board 104. Even though the game board 104 may be covered by a plastic, glass, or resin cover, it may be desirable to keep the marbles 102b in contact with the game board 104. The obstacles 106 may be set into the game board 104 with rotational symmetry. The obstacles 106 may be configured with translational symmetry. The obstacles 106 may be configured without any symmetry.

The gaming system may comprise a base 116 upon which the game board 104 and the finish lane 110 sit. The base 116 may comprise a static display, or the base 116 may comprise a dynamic display, such as a video image display. The base 116 may be configured with a dynamic display to display results of a particular game or to display results of a plurality of games.

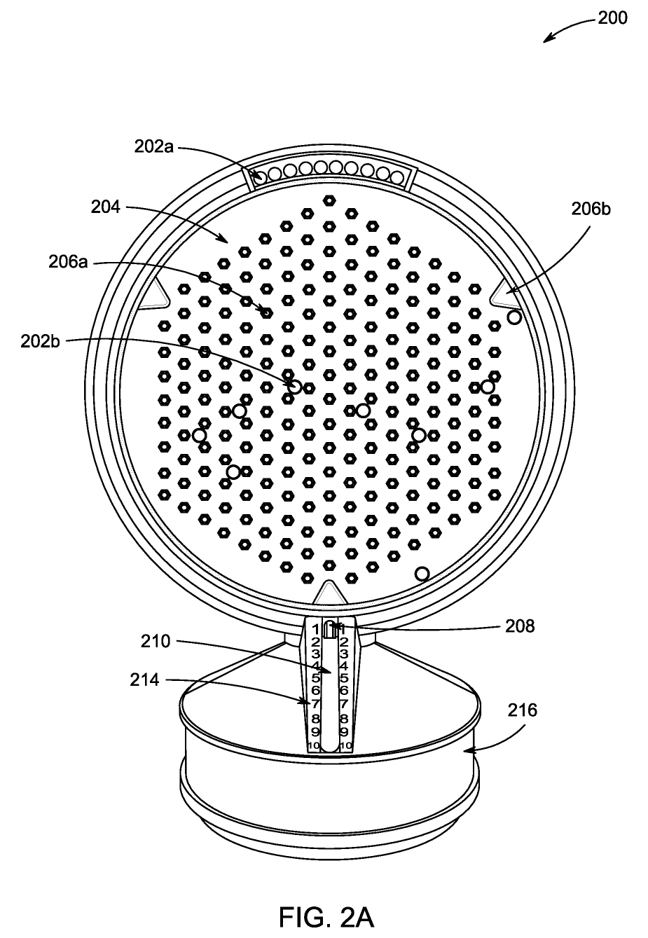

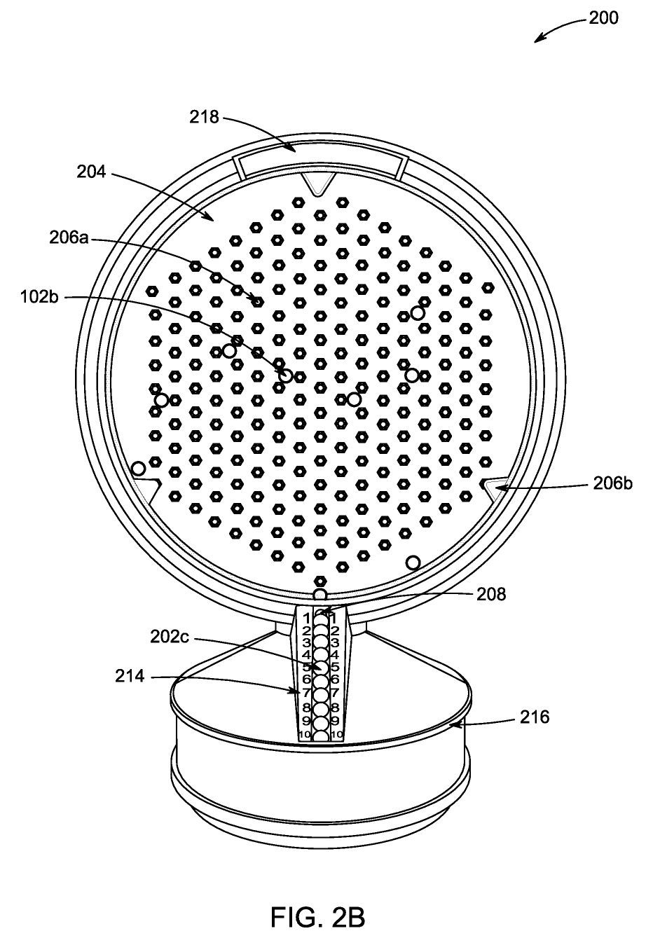

FIG. 2A shows an example head-on view of the plinko-style amusement game 200 in a first game state. The amusement game device may comprise a game board 204 that facilitates the game. The marbles 202 may traverse through the game board 204 during each game from a top to a bottom of the game board 204. The game board 204 may be rotated during the games to change a direction of the marbles 102b in a play area of the game board 204. The rotation may cause a constant change in direction of the marbles 202b in the game area. Users may wager on an outcome of the game. The marbles 202a may be released into the game board 204 as users enter wagers about the game. However, the users may still be allowed to place wagers on the game as the marbles 202b are in the play area of the game board 204. The game board 204 may be rotated in a manner that is particularly determined to prevent any of the marbles 202b to reach a finish gate 208 for a first period of time. During the first period of time users may be allowed to continue placing wagers on the outcome of the game, while the marbles 202b are bouncing around in the game board 204. The wagering taking place while the marbles 202b are already in the play area may build suspense and excitement about which marbles 202b will pass through the finish gate 208 first.

The amusement game may comprise multiple sets of marbles. For example, a set of marbles 202a may be held in a hopper above the top of the rotating game board 204, and upon initiation of a game the marbles 202a may be released into the game board 204. A second set of marbles 202b may be actively in transit through the game board 204 between the finish lane 210 and the hopper. The marbles 202b in the game board 204 may be wagered upon by users participating in the amusement game. The marbles 202b may remain in the game board 204 for a variable amount of time before the rotation of the game board 204 stops. The game board 204 may be rotated in a first direction while a first set of marbles is passing through the game board 204. The game board 204 may be rotated in a second, different direction when using a second set of marbles.

The finish lane 210 may accept marbles as the marbles reach a lower portion of the game board 204 and pass through the finish gate 208. The marbles may be ordered based on an order of passing through the finish gate 208. The marbles used in the amusement game may be printed with different numbers, colors, or symbols that correspond to particular outcomes of games. The marbles may not be printed with any visible differences, but the marbles may be identifiable. For example, the marbles may comprise radio frequency identifier (RFID) tags, and an RFID sensor may be able to determine the order of the marbles in the finish lane 210. The first set of marbles and the second set of marbles may comprise different combinations of identifiers, numbers, colors, symbols, or other identifiers.

The obstacles 206a on the game board 204 may be similar to pegs. The obstacles 206a may be circular and cause the marbles 202b to ricochet upon making impact. The obstacles 206a may be square, oblong, multi-sided, or any other shape. The obstacles 206a may be placed in a repeating manner and each obstacle 206a may be at a constant distance from other obstacles 206a on the game board 204. The obstacles 206a may be configured to keep the marbles 202b against the game board 204. The obstacles 206a may have a relatively narrower shaft and a relatively wider head to prevent the marbles 202b from ricocheting out away from the surface of the game board 204. Even though the game board 204 may be covered by a plastic, glass, or resin cover, it may be desirable to keep the marbles 202b in contact with the game board 204. The obstacles 206 may be set into the game board 204 with rotational symmetry. The obstacles 206 may be configured with translational symmetry. The obstacles 206 may be configured without any symmetry.

Additional obstacles 206b may be set into the game board 204. The obstacles 206b may comprise triangles, wedges, hemispheres, or any other shape. The obstacles 206b may be fastened to the game board 204 at a side of the game board 204. The obstacles 206b may act as ramps or mixers to ricochet marbles 202b from an outer rim of the game board 204 back into the obstacles 206a.The obstacles 206b may be in a repeating pattern on the game board 204.

The gaming system comprises a base 216 upon which the game board 204 and the finish lane 210 attach. The base 216 may comprise a static display, or the base 216 may comprise a dynamic display, such as a video image display. The base 216 may be configured with a dynamic display to display results of a particular game or to display results of a plurality of games.

FIG. 2B shows an example front view of the plinko-style amusement game 200 in a second game state. For example, the game board 204 may be rotated into a different configuration than shown in FIG. 2A. For example, in FIG. 2A the game board 204 is rotated so that an obstacle 206b is positioned at a bottom of the game board 204 near the finish gate 208. This may prevent marbles 202b from exiting the game board 204 and allow the game to continue for a longer period of time. In FIG. 2B the game board 204 is rotated so that there is no obstacle 206b positioned at the bottom of the game board 204 such that marbles 202b may exit the game board 204. The game board 204 may be continuously rotated during a first portion of a game, and the game board 204 may be stopped at a particular position during a second portion of the game. However, the game board may be stopped at any number of positions. For example, the rotation of the game board 204 may be ceased in response to a trigger that is not related to the position of the game board 204. Therefore, the game board 204 may come to a rest at any rotational position. Alternatively, the rotation of the game board 204 may be ceased after a trigger that at least partially comprises a position of the game board 204. In such a scenario, the game board 204 may always come to rest at one or at a same plurality of positions.

Referring to FIG. 2A, a set of marbles 202a is shown in the hopper above the game board 204, awaiting a start of a next game to be released into the game board 204. FIG. 2A also shows a set of marbles 202b in the game board 204 showing a game is actively occurring. In FIG. 2B, a set of marbles 202c has reached a bottom of the game board 204 and each one of the marbles 202c has passed through the finish gate 208 into the finish lane 210. The order indicators 214 show the order of the marbles 202c in the finish lane 210 and indicate an outcome of one or more wagers placed on the game. Additionally, FIG. 2B shows that a new game has begun, in which marbles 202b have been released into the game board 204 and are bouncing through toward the bottom of the game board 204. Ideally, the marbles in the finish line 210 will be emptied before the marbles in the play area of the game board 204 reach the finish gate 208, but even if they do, the finish gate may not be opened until the finish line has been emptied.

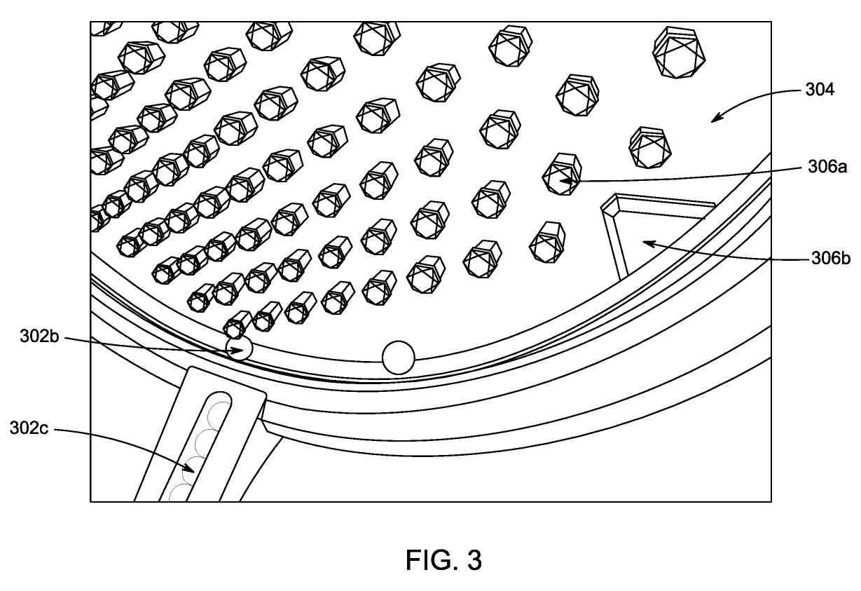

FIG. 3 shows a close-up view of a portion of the game board 304 near a bottom of the game board 304. The close-up view shows a group of marbles 302c in a finish lane of the amusement game, indicating a game has finished and an outcome of zero, one, or more wagers has been processed. Additionally, a plurality of marbles 302b are falling through the game board 304, ricocheting off obstacles 306a and 306b as the marbles 302b traverse through the game board 304. With a set of marbles 302c actively inside the finish lane, the game system may not allow any additional marbles 302b to enter the finish lane. The finish gate may be closed to marbles 302b. Therefore, even if the marbles 302b manage to traverse the game board 304 and reach the bottom of the game board 304, the marbles 302b may not be able to pass through the closed finish gate and into the finish lane. The game board 304 may be rotating and the obstacle 306b may dislodge marbles 302b that are sitting at the bottom of the game board 304 and ricochet the marbles 302b back up into the obstacles 306a.

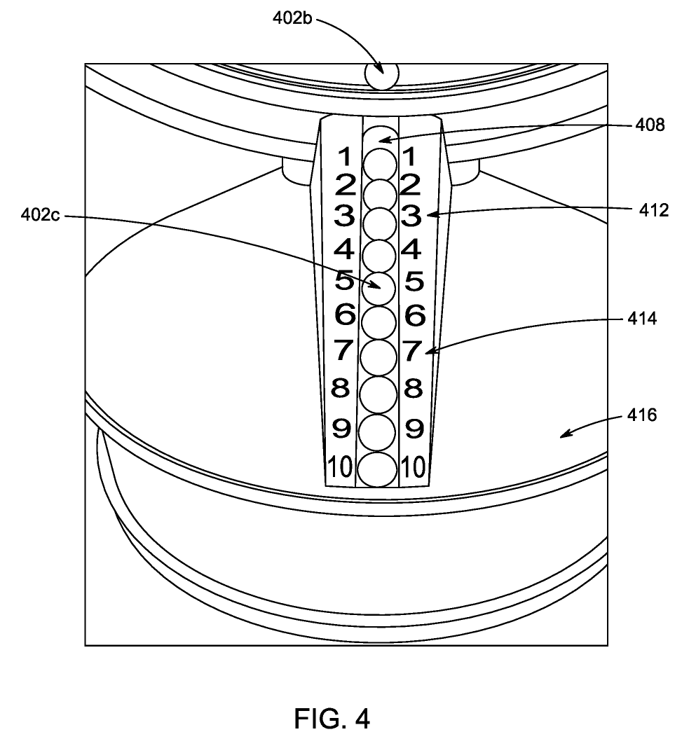

FIG. 4 shows an example close-up view of a finish lane 410 of the amusement game system with marbles 402c lined up in an order. Marbles 402c are lined up in the finish lane in the order the marbles 402c passed through the finish gate 408 and are displayed as an outcome of a game. The outcome of the game may be indicated by the order indicators 414.

The finish lane may show the marbles 402c in an ordering of first to last or last to first. Thus, the marble farthest away from the game board 404 may be the marble 402c that passed through the finish gate 408 first, or the marble 402c that is closest to the game board 404 in the finish lane may be the marble 402c that passed through the finish gate 408 first. Though the finish lane is shown as a single-file lane of the marbles, other embodiments are contemplated herein. For example, the finish lane may comprise a square grid, for example a 3x3 grid. Nine marbles may be used in a game with a finish lane having a 3x3 square grid. The configuration of the marbles 402c in the 3x3 grid may correspond to an outcome of the game. For example, classic slot machines typically reveal a 3x3 grid of symbols, and determinations of winning and losing wagers on the classic slot machines is determined by the configuration of the symbols. In the same way, the outcome of the ordering of the marbles 402c in the 3x3 grid version of the finish lane may be determined by the configuration of the marbles 402c. For example, three of the nine marbles may be a same color, and a game may be considered a win if the three marbles of the same color are aligned vertically, horizontally, and/or diagonally. Many such combinations of marbles and grids may be possible to enhance the novelty and excitement of the amusement game system. Marbles may be printed with different numbers, colors, or symbols that correspond to particular outcomes of games. The marbles may not be printed with any visible differences, but the marbles may be identifiable. For example, the marbles may comprise radio frequency identifier (RFID) tags, and an RFID sensor may be able to determine the order of the marbles in the finish lane. The finish lane may be too small to accommodate every marble, and only some marbles may enter the finish lane, which is another mechanism for determining outcomes of the amusement games.

The order indicators and the finish lane may comprise back lights 412 to light up and provide entertainment to the determination of the outcome of the game. For example, the finish lane under the marbles 402c and the order indicators 414 may light up with colors from the back lights 412. The back lights 412 may provide a constant source of light, for example white light. However, the back lights 412 may change color periodically or in response to a trigger. For example, the back lights 412 may transition from one color to another color after a period of several seconds. The back lights 412 may transition to a color corresponding to a first marble 402c in the order. Users may not be able to easily tell from looking at the finish lane which marble of the marbles 402c passed through the finish gate 408 first, but the back lights 412 may light up in the color of the first marble that passed through the finish gate 408 to more readily indicate the outcome of the ordering of the marbles 402c. The back lights 414 may light up in a gradient. The gradient may be random or pre-determined. The gradient may correspond to the order of the marbles 402c. For example, the back lights 412 may light up under each marble of the marbles 402c in a same color as the corresponding marble.

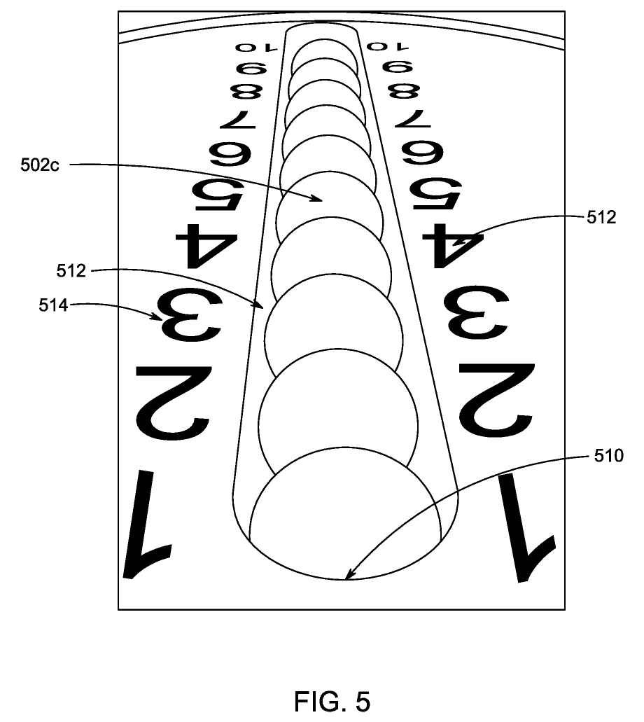

FIG. 5 shows a close-up view of the finish lane 510. The marbles 502c are ordered in an order of passing through a finish gate and into the finish lane 510. The order indicators 514 indicate a position of each one of the marbles 502c in the outcome of the game. The back lights 512 may comprise white light to illuminate the finish lane 510. For example, the back lights 512 may illuminate both the order indicators 514 and the underside of the finish lane 510. The back lights 512 may comprise a single color or any number of colors.

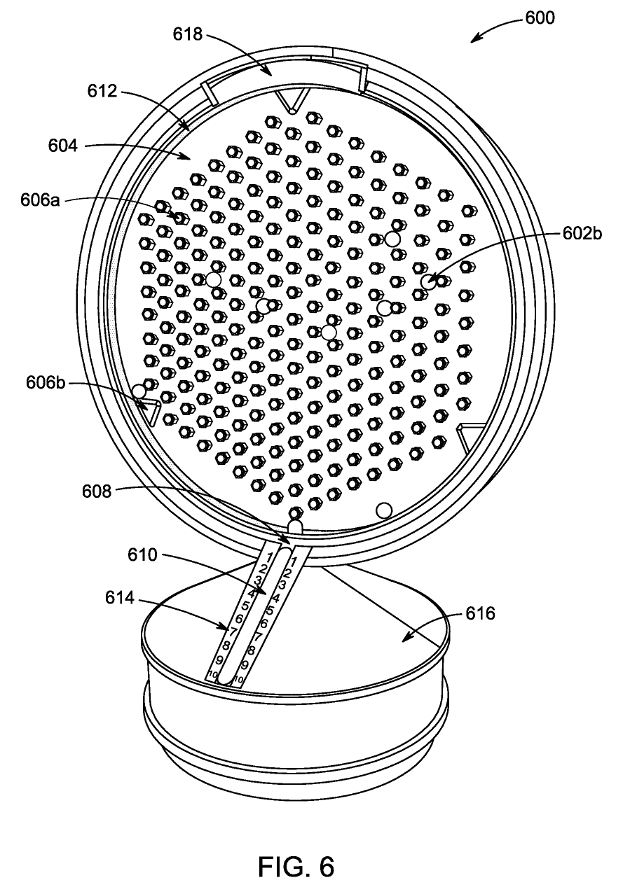

FIG. 6 shows an example amusement game system 600, as described above. The amusement game system may comprise a game board 604 that facilitates the game. The marbles may traverse through the game board 604 during a game from a top to a bottom of the game board 604. The game board 604 may be rotated during the game to change a direction of the marbles 602b in a play area. The rotation may cause a change in direction of the marbles 602b falling down through the game board 604 and build suspense and excitement about which marbles 602b will pass through a finish gate 608 first.

Marbles may be held in a hopper 618 above the top of the rotating game board 604, and upon initiation of a game the marbles may be released into the game board 604. The marbles 602b actively in transit through the game board 604 may take seconds or minutes to traverse through the game board 604 and to the finish gate 608, typically depending on a length of a period of time the game board 604 is rotated. The game board 604 may be rotated in either direction. Though typically only rotated in one direction for the entirety of a game, the game board 604 rotation may change direction during the middle of an active game. Marbles may pass through the finish gate 608 and enter the finish lane 610. Marbles may be lined up in the finish lane 610 in an order associated with the order the marbles passed through the finish gate 608.

The game board 604 may comprise one or more back lights 612 to light up the game board 604 and finish lane 610. For example, the back lights may be light emitting diodes (LEDs), incandescent lights, fluorescent lights, or the like. The back lights 612 may be inset in a rim of the game board 604 to cast light inward on to the game board 604 to increase illumination of the marbles 602b. The back lights may stay a same color or may change color periodically or based on certain conditions of the games. The back lights 612 may change color to match a color or other identity of a marble 602b passing through the finish gate 608 or settling into a position in the finish lane 610.

The obstacles 606a on the game board 604 may be similar to pegs. The obstacles 606a may be circular and cause the marbles 602b to ricochet upon making impact. The obstacles 606a may be square, oblong, multi-sided, or any other shape. The obstacles 606a may be placed in a repeating manner and each obstacle 606a may be at a constant distance from other obstacles 606a on the game board 604. The obstacles 606 may be configured to keep the marbles 602b against the game board 604. The obstacles 606a may have a relatively narrower shaft and a relatively wider head to prevent the marbles 602b from ricocheting out away from the surface of the game board 604. Even though the game board 604 may be covered by a plastic, glass, or resin cover, it may be desirable to keep the marbles 602b in contact with the game board 604. The obstacles 606a may be set into the game board 604 with rotational symmetry. The obstacles 606a may be configured with translational symmetry. The obstacles 606a may be configured without any symmetry.

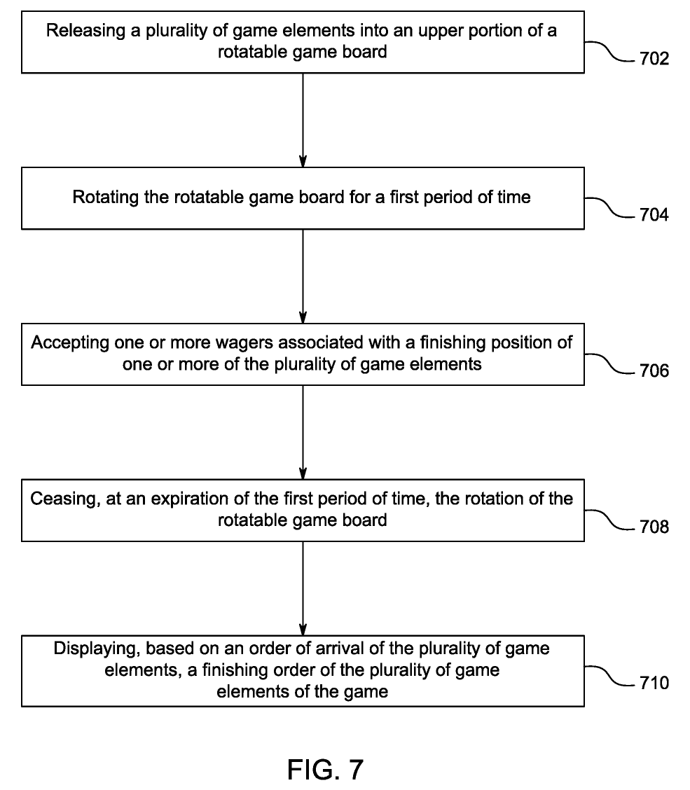

FIG. 7 provides a flow chart of an amusement game operation, in accordance with aspects of the present disclosure. The operations may be carried out by a physical amusement game device, for example amusement game system 100. The operations may be carried out by a computing device. The computing device may be integrated into the amusement game device. The computing device may be separate from the amusement game device. For example, the computing device may be a server device configured to communicate with components of the amusement game device. The computing device may execute instructions that cause the actions describe in FIG. 7.

At block 702, an amusement game may be operated as described herein. The amusement game may comprise a plurality of game elements traversing through a plurality of obstacles on a game board to a bottom of the game board to reach a finish gate. The plurality of game elements may be released into an upper portion of the game board, and the game board may be rotatable. The game elements may be released into the game board while the game board is stationary, or the game elements may be released into the game board while the game board is rotating.

At block 704, the game elements may be traversing through the obstacles on the game board. The game elements may be ricocheting off the obstacles and generally travelling downward toward a bottom portion of the game board via gravity. The game board may be rotating for a first period of time. The game board may rotate clockwise or anti-clockwise. The rotating game board may cause the game elements to change their direction of travel with respect to the rotating game board. Thus, a game element that travelled within a short distance of the bottom of the amusement game device may be rotated with the game board farther away from the bottom of the amusement game device, increasing an amount of time the game element must travel through the obstacles of the game board.

At block 706, the system may accept one or more wagers associated with an outcome of the game. The wagers may be received from one or more users. However, there does not necessarily need to be any users making wagers for a new game to begin. For example, even if no users are actively participating in the game, it may be desirable to periodically carry out games to entice new users to participate with future games at the amusement game system.

The wagers may be received from one or more player stations located near the amusement game device. For example, one or more users may interact with a player station, and the player station may provide a user interface for the one or more users to view. The player station user interface may present one or more wagers that the one or more users may make. The one or more users may enter the wagers to participate with an particular game of the amusement game device. The wagers may be related to a predicted finishing order of the game elements. The wagers may be made while the game elements are bouncing around the game board and ricocheting off obstacles protruding from the game board. At a specified trigger, the game may reach a state in which no further wagers are allowed to be entered.

At block 708, the amusement game system may cause the game board to cease rotation. The trigger to cease the rotation of the game board may be based on a period of time of a wager phase, a number of wagers cast, or an indication that each user or a specified portion of the users desire the wager phase to close. The game board may be fixed in place, allowing for the game elements to travel toward the lower portion of the amusement game device without being rotated farther away from the finish gate. Each one of the plurality of game elements may eventually traverse through the obstacles on the game board, reach the finish gate, and pass through the finish gate to a finish lane. The outcome of the game may be associated with the order the plurality of game elements passed into the finish lane.

At block 710, the amusement game system may display an outcome associated with the order of the plurality of game elements. The outcome displayed may be based on the order of arrival of the plurality of game elements at the finish lane. The previously placed wagers may be decided based on the finishing order of the plurality of game elements. Thus, the users may determine whether a wager is successful based on the order of the game elements. The result of the game may be displayed on the user interface of the player stations. The result of the game may be displayed on a display screen associated with the amusement game system. The result of the game may be displayed on a user device of a user located remotely from the amusement game device.

The techniques described above can be implemented on a computing device associated with a game (e.g., a marble game or some other form of amusement game), a plurality of computing devices associated with a plurality of games, a controller in communication with the game(s) (e.g., a controller configured to synchronize the game(s)), or a plurality of controllers in communication with the game(s), such as a GANLOT AMDY-7005, which is designed for gaming applications. The controller module may also provide outputs for the game’s lighting, operations, and automated functions.

Additionally, the techniques may be distributed between the computing device(s) and the controller(s). FIG. 8 illustrates an exemplary block diagram of a computing system or game server, for games and player stations, which includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/ broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a plurality of game elements, a rotatable game board comprising a plurality of protruding obstacles, a finish lane comprising a plurality of finish position markers, and a computing device may comprise a system for implementation and operation of an amusement game. The computing device may cause release of the plurality of game elements into an upper portion of the rotatable game board to begin a game. The computing device may cause, for a first period of time, rotation of the rotatable game board. The computing device may accept, for the first period of time, one or more wagers associated with a finishing position of one or more of the plurality of game elements. The computing device cause, at an expiration of the first period of time, cessation of the rotation of the rotatable game board, wherein the plurality of game elements are configured to move toward a finish gate at a lower portion of the rotatable game board and enter a finish lane in a chronological order of arrival to the finish gate. The computing device may display, based on the order of arrival of the plurality of game elements, a finishing order of the game elements of the game.

In the embodiment, further comprising one or more player consoles associated with the computing device.

In the embodiment, wherein the computing device is further configured to accept, based on an indication received from one of the one or more player consoles, a wager, and display, on a user interface of the one or more player consoles, an outcome of the game.

In the embodiment, further comprising a game element transportation component to transport the plurality of game elements from the finish lane to a hopper above the upper portion of the rotatable game board.

In the embodiment, wherein the rotation occurs in a first direction during the game, and wherein the rotatable game board may be rotated in a different direction in a subsequent game.

In the embodiment, further comprising a plurality of lights associated with the finish lane and configured to change a color based at least in part on the order of arrival of the plurality of game elements.

In the embodiment, further comprising a game element grid coupled to the finish gate and configured to order the plurality of game elements in the grid based on the chronological order of arrival of the plurality of game elements at the finish gate.

In the embodiment, wherein the computing device is further configured to end, upon expiration of the first period of time, acceptance of wagers. The computing device may rotate the rotatable game board for a second period of time. The computing device may cause, at an expiration of the second period of time, the cessation of the rotation of the rotatable game board.

In the embodiment, further comprising an optical recognition component, wherein the computing device is further configured to receive, from the optical recognition component, an indication of the order of arrival of the plurality of game elements.

In the embodiment, wherein the plurality of game elements each comprise a radio frequency identifier (RFID) tag, wherein the computing device is further configured to receive, from an RFID component, an indication of the order of arrival of the plurality of game elements.

Conditional language used herein, such as, among others, "can," "could," "might," "may," “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A system comprising:
a plurality of game elements;
a rotatable game board comprising a plurality of protruding obstacles;
a finish lane comprising a plurality of finish position markers; and
a computing device configured to:
cause release of the plurality of game elements into an upper portion of the rotatable game board to begin a game;
cause, for a first period of time, rotation of the rotatable game board;
accept, for the first period of time, one or more wagers associated with a finishing position of one or more of the plurality of game elements;
cause, at an expiration of the first period of time, cessation of the rotation of the rotatable game board, wherein the plurality of game elements are configured to move toward a finish gate at a lower portion of the rotatable game board and enter a finish lane in a chronological order of arrival to the finish gate; and
display, based on the order of arrival of the plurality of game elements, a finishing order of the plurality of game elements of the game.

2. The system of claim 1, further comprising one or more player consoles associated with the computing device.

3. The system of claim 2, wherein the computing device is further configured to:
accept, based on an indication received from one of the one or more player consoles, a wager; and
display, on a user interface of the one or more player consoles, an outcome of the game.

4. The system of claim 1, further comprising a game element transportation component to transport the plurality of game elements from the finish lane to a hopper above the upper portion of the rotatable game board.

5. The system of claim 1, wherein the rotation occurs in a first direction during the game, and wherein the rotatable game board may be rotated in a different direction in a subsequent game.

6. The system of claim 1, further comprising a plurality of lights associated with the finish lane and configured to change a color based at least in part on the order of arrival of the plurality of game elements.

7. The system of claim 1, further comprising a game element grid coupled to the finish gate and configured to order the plurality of game elements in the grid based on the chronological order of arrival of the plurality of game elements at the finish gate.

8. The system of claim 1, wherein the computing device is further configured to:
end, upon expiration of the first period of time, acceptance of wagers;
rotate the rotatable game board for a second period of time; and
cause, at an expiration of the second period of time, the cessation of the rotation of the rotatable game board.

9. The system of claim 1, further comprising an optical recognition component, wherein the computing device is further configured to:
receive, from the optical recognition component, an indication of the order of arrival of the plurality of game elements.

10. The system of claim 1, wherein the plurality of game elements each comprise a radio frequency identifier (RFID) tag, wherein the computing device is further configured to:
receive, from an RFID component, an indication of the order of arrival of the plurality of game elements.

11. A method comprising:
releasing a plurality of game elements into an upper portion of a rotatable game board to begin a game;
rotating, for a first period of time, the rotatable game board;
accepting, for the first period of time, one or more wagers associated with a finishing position of one or more of the plurality of game elements;
ceasing, at an expiration of the first period of time, the rotation of the rotatable game board, wherein the plurality of game elements are configured to move toward a finish gate at a lower portion of the rotatable game board and enter a finish lane in a chronological order of arrival to the finish gate; and
displaying, based on the order of arrival of the plurality of game elements, a finishing order of the plurality of game elements of the game.

12. The method of claim 11, further comprising one or more player consoles associated with the computing device.

13. The method of claim 12, further comprising:
accepting, based on an indication received from one of the one or more player consoles, a wager; and
displaying, on a user interface of the one or more player consoles, an outcome of the game.

14. The method of claim 11, further comprising a game element transportation component transporting the plurality of game elements from the finish lane to a hopper above the upper portion of the rotatable game board.

15. The method of claim 11, wherein the rotating occurs in a first direction during the game, and wherein the rotatable game board may be rotated in a different direction in a subsequent game.

16. The method of claim 11, further comprising a plurality of lights associated with the finish lane and configured to change a color based at least in part on the order of arrival of the plurality of game elements.

17. The method of claim 11, further comprising a game element grid coupled to the finish gate and configured to order the plurality of game elements in the grid based on the chronological order of arrival of the plurality of game elements at the finish gate.

18. The method of claim 11, further comprising:
ending, upon expiration of the first period of time, acceptance of wagers;
rotating the rotatable game board for a second period of time; and
ceasing, at an expiration of the second period of time, the rotation of the rotatable game board.

19. The method of claim 11, further comprising determining, by an optical recognition component, an indication of the order of arrival of the plurality of game elements.

20. The method of claim 11, wherein the plurality of game elements each comprise a radio frequency identifier (RFID) tag, further comprising determining, by an RFID component, an indication of the order of arrival of the plurality of game elements.
